(19) United States
(12) Patent Application Publication
(10) Pub. No.: US 2018/0350152 A1
(43) Pub. Date: Dec. 6, 2018

(54) 3D Scanning Large Structures in Parallel by Scanning an Individual Space Plus Overlapping Geometry of Adjacent Space

(71) Applicant: SPAWAR System Center Pacific, San Diego, CA (US)

(72) Inventors: Mark Bilinski, Vista, CA (US); Stephen C. Cox, San Marcos, CA (US); Larry C. Greunke, Lakeside, CA (US); Nikolai V. Lukashuk, San Diego, CA (US)

(73) Assignee: United States of America as represented by Secretary of the Navy, San Diego, CA (US)

(21) Appl. No.: 15/610,299

(22) Filed: May 31, 2017

(51) Int. Cl. G06T 19/20; G06T 17/05; G06K 9/46

(52) U.S. Cl. CPC G06T 19/20; G06T 2207/30232; G06K 9/4609; G06T 17/05

(57) ABSTRACT

An imaging system includes: a first imaging data receiving component that receives first three-dimensional image data of a first area and a portion of a second area; a first data storage component that stores the first three-dimensional image data; a second imaging data receiving component that receives second three-dimensional image data of the second area and a portion of the first area; a second data storage component that stores the second three-dimensional image data; a stitching component that stitches the first three-dimensional image data together with the second three-dimensional image data to produce stitched three-dimensional image data of the first area and the second area; and a stitched data storage component that stores the stitched three-dimensional image data. The first area is optically isolated from the second area with the exception of through a throughway.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 36000, San Diego, Calif., 92152; telephone (619) 553-5118; email: ssc_pac_t2@navy.mil. Reference Navy Case No. 105,302.

### BACKGROUND OF THE INVENTION

Embodiments of the invention relate to three-dimensional (3D) scanning of large spaces.

Scanning a large space in 3D can be advantageous for a number of reasons. Having a digital, 3D rendering of a space allows a future user of the space to “virtually” walk through the space prior to actual use. In the instance of a commander of a naval ship, for example, it is beneficial for the commander to understand the layout and feel of the ship before embarking on a mission. Having a 3D scanned image of a space can also aid in generating accurate bids for future construction work on a space. For these advantages to be fully realized, though, the 3D scanned images should be accurate, and 3D scanning a large space accurately presents a number of challenges.

In many cases, a large space cannot easily be cleared out to prepare for scanning, and the logistics become very difficult to navigate. Thus, a system and method is needed to scan large spaces by providing the ability to scan smaller parts of the larger space and stitch the scans together.

### SUMMARY OF THE INVENTION

An aspect of the present invention is drawn to an imaging system that includes: a first imaging data receiving component that receives first three-dimensional image data of a first area and a portion of a second area; a first data storage component that stores the first three-dimensional image data; a second imaging data receiving component that receives second three-dimensional image data of the second area and a portion of the first area; a second data storage component that stores the second three-dimensional image data; a stitching component that stitches the first three-dimensional image data together with the second three-dimensional image data to produce stitched three-dimensional image data of the first area and the second area; and a stitched data storage component that stores the stitched three-dimensional image data. The first area is optically isolated from the second area with the exception of through a throughway. The portion of the second area comprises a portion of the second area as optically viewed from the first area through the throughway. The portion of the first area comprises a portion of the first area as optically viewed from the second area through the throughway.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIGS. 1A-B illustrate the physical layout of a space to be 3D scanned and the resulting digital layout after imaging;

FIG. 2 illustrates a floor plan of a space to be 3D scanned;

FIG. 3 illustrates a method of generating an image in accordance with aspects of the present invention;

FIG. 4 illustrates a system for storing and stitching images in accordance with aspects of the present invention;

FIG. 5A illustrates two spaces prepared for 3D scanning in accordance with aspects of the present invention;

FIG. 5B illustrates scanning a first space and an adjacent portion of a second space in accordance with aspects of the present invention;

FIG. 5C illustrates scanning the second space and the adjacent portion of the first space in accordance with aspects of the present invention;

FIG. 5D illustrates scanning the second space without scanning the adjacent portion of the first space in accordance with aspects of the present invention;

FIGS. 6A-B illustrate stitching of the 3D scanned images according to aspects of the present invention;

FIGS. 7A-B illustrate a proxy layout of a floor plan using nodes and arrows; and

FIG. 8 illustrates the stitched image according to aspects of the present invention.

### DETAILED DESCRIPTION OF THE EMBODIMENTS

The present invention provides a system and method to accurately 3D scan a large space.

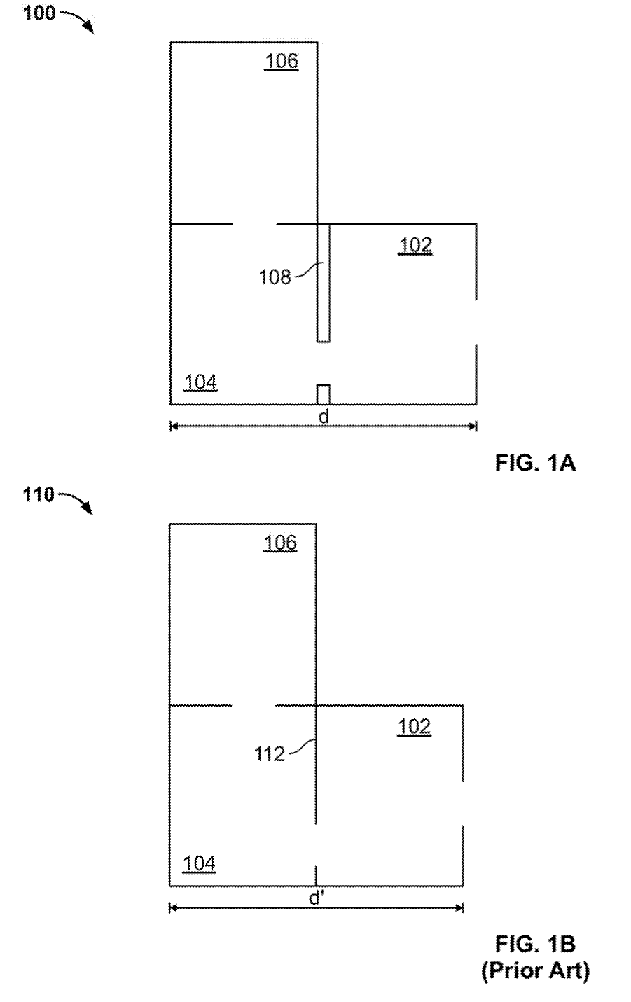

FIGS. 1A-B illustrate a physical layout 100 of a space to be 3D scanned and the resulting digital layout after imaging, respectively.

As shown in FIG. 1A, physical layout 100 includes a room 102, a room 104, a room 106 and a wall 108. For purposes of discussion, suppose a typical wall separating two rooms is approximately six inches (6″) thick, and suppose wall 108 is thicker than a typical wall in between two rooms because there are multiple utilities running through wall 108 that require wall 108 to be thicker to appropriately accommodate the utilities. Because of this extra thickness, the overall length of the space from room 102 to room 104 is d.

Now suppose that rooms 102, 104, and 106 are being 3D imaged. Using conventional 3D imaging techniques, the user performing the imaging scans room 102, then walks into room 104 and scans room 104, then walks into room 106 and scans room 106. The user may believe that the space has been accurately captured, however the scan has not accounted for the additional thickness of wall 108 because wall thicknesses are typically assumed to be conventional. As a result, as shown in FIG. 1B, the digital layout 110 includes wall 112 that looks as though it is a conventional thickness. The overall length of the space from room 102 to room 104 is miscalculated as d′, which is less than d.

This variation in wall thickness, which may seem minor in isolation, may become a major problem when scanning large spaces and presumably minor measurement issues are compounded, resulting in a digital space that does not accurately represent the physical space. This inaccuracy can result in inaccurate bids for construction purposes, and lost time and money when parts and supplies are ordered based on the digital representation of the space. Thus, a system and method is needed to accurately 3D scan a large space.

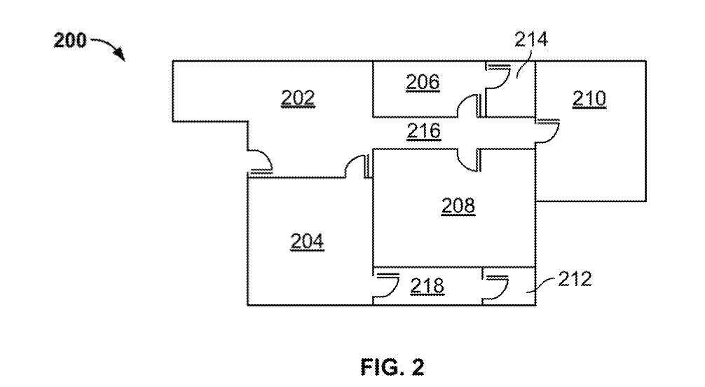

FIG. 2 illustrates a floor plan 200 of a space to be 3D scanned.

As shown in the figure, floor plan 200 includes rooms 202, 204, 206, 208, 210, 212, and 214, and hallways 216 and 218. Floor plan 200 is large, and in order to scan the entire space in a single imaging session, significant preparation is involved. The space may need to be cleaned to avoid inaccuracies during scanning. Additionally, any personnel in the space will have to be removed, and registration targets may need to be deployed in each room to provide reference points during the scanning process. In addition, a detailed scanning plan should be generated to assure the space is scanned appropriately.

Scanning a large space like floor plan 200 in this manner not only includes the potential of compounding small errors as discussed with reference to FIGS. 1A-B, but also the logistical problems associated with preparing a large space for scanning, and then taking the time to scan the space in a single scanning session. In many cases, a large space cannot easily be cleared out to prepare for scanning, and the logistics become very difficult to navigate. Thus, a system and method is needed to scan large spaces by providing the ability to scan smaller parts of the larger space and stitch the scans together.

Embodiments of the present invention provide for using any known type of 3D scanner to scan a first room within a large space, and a portion of a second room adjacent to the first room, visible through a throughway or portal. The 3D scanner is then used to scan the second room. The 3D images of the first room and second room are stitched together using registration targets in the second room that are visible from the scan of the second room and also visible from the scan of the portion of the second room from the first room. Stitching 3D images together in this manner provides for more accurate images that can be recorded piecemeal rather than scanning a large space in a single scanning session.

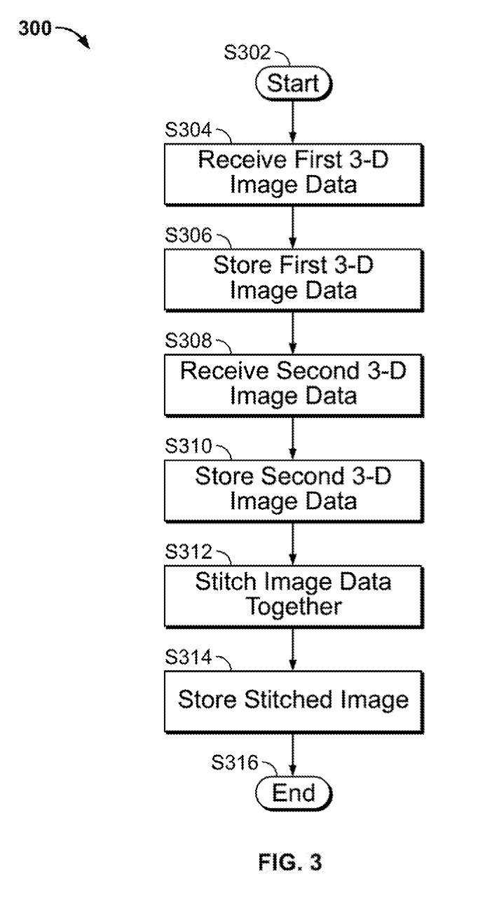

Aspects of the present invention will now be discussed with reference to FIGS. 3-8.

FIG. 3 illustrates a method of generating an image in accordance with aspects of the present invention.

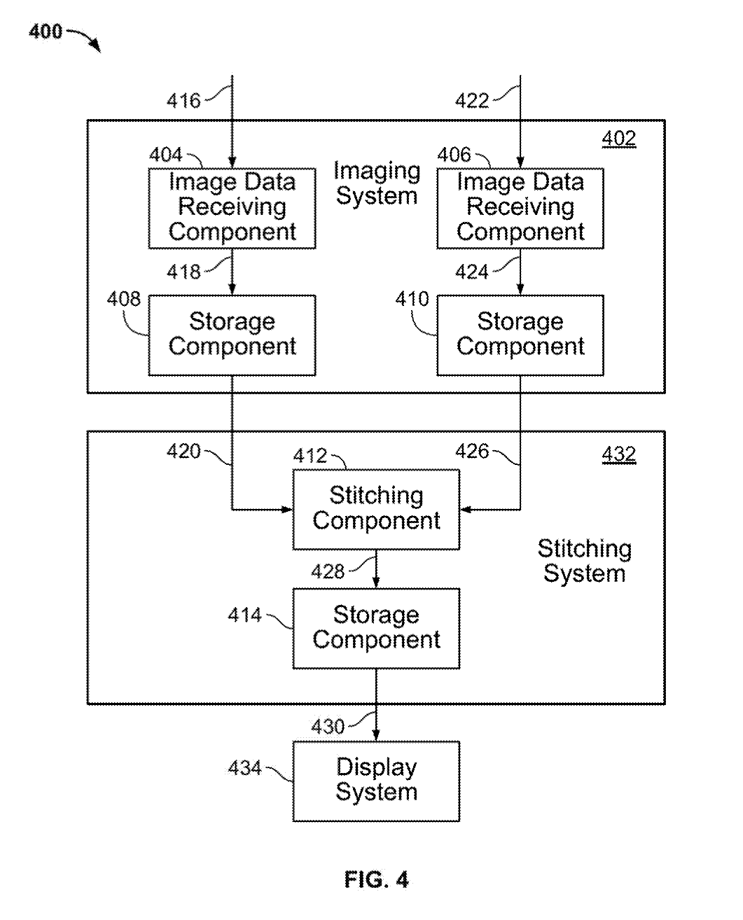

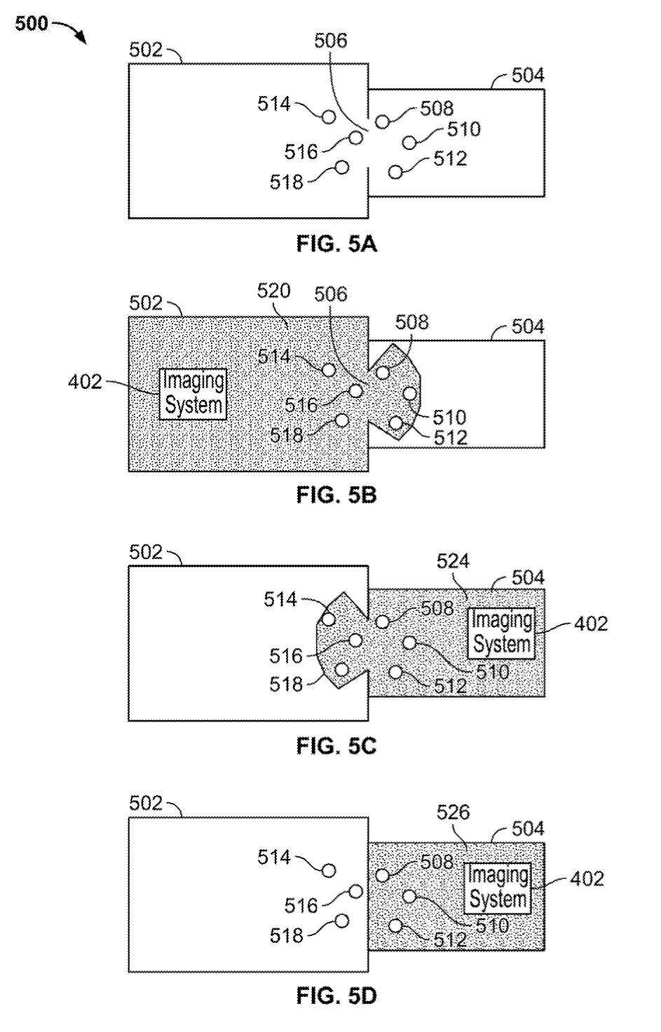

As shown in the figure, method 300 starts (S302) and a first 3D image is received (S304). This will be further described with reference to FIG. 4 and FIGS. 5A-D.

FIG. 4 illustrates a system 400 for storing and stitching images in accordance with aspects of the present invention.

As shown in the figure, system 400 includes an imaging system 402, a stitching system 432, and a display system 434.

Imaging system 402 further includes an imaging data receiving component 404, an imaging data receiving component 406, a storage component 408, and a storage component 410. Imaging data receiving component 404 communicates with storage component 408 via communication channel 418, and imaging data receiving component 406 communicates with storage component 410 via communication channel 424.

Imaging system 402 may be any known 3D scanning technology designed to record and store 3D images. Non-limiting examples of conventional 3D scanning technology include, Light Distance and Ranging (LiDAR), depth cameras, structure from motion (SfM), simultaneous localization and mapping (SLAM), and Kinect.

Imaging data receiving components 404 and 406 may be any type of device or system within imaging system 402 that receives the three-dimensional image data associated with the desired 3D images.

Storage components 408 and 410 may be any type of device or system within imaging system 402 that stores the data received by imaging data receiving components 404 and 406, respectively. Non-limiting examples of storage components 408 and 410 include RAM, ROM, EEPROM, CD-ROM or other optical disk storage, magnetic disk storage or other magnetic storage devices.

In this example embodiment, only two imaging data receiving components are shown for purposes of discussion, however it is possible to have more or fewer imaging data receiving components within imaging system 402. In addition, in this embodiment, only two storage components are shown for purposes of discussion, however it is possible to have more or fewer storage components within imaging system 402.

In this example embodiment, imaging system 402 is illustrated as a single element for purposes of discussion. However, it should be noted that an imaging system used in accordance with aspects of the present invention may be a plurality of imaging systems, either identical or fundamentally different, so long as the generated image data is compatible for stitching. If multiple imaging systems are used, the work of scanning a large space may be distributed in parallel by multiple independent teams. As such, a large ship may be scanned in a short amount of time.

In this example embodiment, imaging data receiving component 404, imaging data receiving component 406, storage component 408, and storage component 410 are illustrated as individual devices. However, in some embodiments, at least two of imaging data receiving component 404, imaging data receiving component 406, storage component 408, and storage component 410 may be combined as a unitary device.

Stitching system 432 further includes stitching component 412 and storage component 414. Stitching component 412 communicates with storage component 408 via communication channel 420 and with storage component 410 via communication channel 426.

Stitching component 412 may be any device or system designed to receive a plurality of 3D images and create a single 3D image from the plurality of 3D images by aligning registration targets between the 3D images.

Display system 434 communicates with storage component 414 via communication channel 430. Display system 434 is any device or system that can display the 3D image to a viewer. Non-limiting examples of display system 434 include televisions, computer monitors, tablet computer displays, mobile phone displays, and virtual reality displays.

In this embodiment, imaging system 402, stitching system 432, and display system 434 are illustrated as individual devices. However, in some embodiments, imaging system 402, stitching system 432, and display system 434 may be combined as a unitary device.

FIG. 5A illustrates two rooms prepared for 3D scanning in accordance with aspects of the present invention.

As shown in the figure, a space 500 includes a room 502, a room 504, a throughway 506, and registration targets 508, 510, 512, 514, 516, and 518. Registration targets 508, 510, 512, 514, 516, and 518 may be any object that is distinctive and can be identified. They may be distinctive items already in a space, like a post or a beam, or they may be items placed specifically in the space for registration purposes.

For purposes of discussion, suppose a 3D scan of space 500 was desired. Furthermore, suppose space 500 is sufficiently large that it is not possible to conduct a 3D scan of the entire space 500 in a single scanning session. In addition, room 502 cannot be fully viewed from within room 504, and room 504 cannot be fully viewed from within 502, so rooms 502 and 504 are optically isolated from each other. Therefore, room 502 will be scanned during one scanning session, and room 504 will be scanned during a second scanning session.

To prepare for scanning room 502, registration targets 508, 510, and 512 are placed in room 504 such that they can be scanned from room 502 through throughway 506. To prepare for scanning room 504, registration targets 514, 516, and 518 are placed in room 502 such that they can be scanned from room 504 through throughway 506.

FIG. 5B illustrates scanning a first room and an adjacent portion of a second room in accordance with aspects of the present invention.

As shown in the figure, imaging system 402 has conducted a 3D scan at a first time resulting in 3D image 520, which includes a 3D image of room 502 and a 3D image of a portion of room 504 viewable through door 506. 3D image 520 includes registration targets 508, 510, 512, 514, 516, and 518.

Returning to FIG. 4, imaging system 402 receives 3D image 520 via communication channel 416, and 3D image 520 is received by imaging data receiving component 404.

Returning to FIG. 3, after the first 3D image is received (S304), the first 3D image is stored (S306).

Referring to FIG. 4, image 520 is transferred from imaging data receiving component 404 to storage component 408.

Returning to FIG. 3, after the first 3D image is stored (S306), the second 3D image is received (S308). This will be further described with reference to FIGS. 5A, 5C, and 5D.

Referring to FIG. 5A, it is now desired to scan room 504 during a second scanning session. The second scanning session may occur at a different time than when the first scanning session occurred. For example, the scanning team may have had a limited amount of time to scan room 502 during the first scanning session and therefore had to return at a later time to scan room 504. Registration targets 514, 516, and 518 were previously placed in room 502 such that they can be scanned from room 502 through throughway 506.

FIG. 5C illustrates scanning the second room and the adjacent portion of the first room in accordance with aspects of the present invention.

As shown in the figure, imaging system 402 has conducted a 3D scan, resulting in 3D image 524, which includes a 3D image of room 504 and a 3D image of a portion of room 502. The 3D image 524 includes registration targets 508, 510, 512, 514, 516, and 518.

FIG. 5D illustrates scanning the second room without scanning the adjacent portion of the first room in accordance with aspects of the present invention.

As shown in the figure, imaging system 402 has conducted a 3D scan a second time t₂, resulting in 3D image 526, which includes a 3D image of room 504. It should be noted that in some embodiments, the second 3D image data may be received (S308) right when the first 3D image data is received (S304), such that t₁ is substantially the same as t₂, whereas in other embodiments, the second 3D image data may be received (S308) long after the first 3D image data is received (S304), such that t₁ is much earlier than t₂.

The 3D image 526 includes registration targets 508, 510, and 512. It may be necessary to scan room 504 without scanning the adjacent portion of room 502 for various reasons. In one embodiment, room 502 may be in use at the time room 504 is scanned, requiring door 506 to be closed. In another embodiment, the individual scanning room 504 may have unintentionally closed door 506 prior to the scan. In another embodiment, registration targets 514, 516, and 518 may have been removed from room 502, thus providing no incentive to scan the adjacent portion of room 502 when scanning room 504.

Returning to FIG. 4, imaging system 402 receives 3D image 524 via communication channel 422, and 3D image 524 is received by imaging data receiving component 406.

Returning to FIG. 3, after the second 3D image is received (S308), the second 3D image is stored (S310).

Referring to FIG. 4, image 524 is transferred from imaging data receiving component 406 to storage component 410. In an alternate embodiment where imaging system 402 captures image 526, image 526 is transferred from imaging data receiving component 406 to storage component 410.

Returning to FIG. 3, after the second 3D image is stored (S310), the image data is stitched together (S312). This will be further described with reference to FIGS. 4, 7A, 7B, and 8.

Referring to FIG. 4, image 520 is transferred from storage component 408 to stitching component 412, and image 524 is transferred from storage component 410 to stitching component 412. In an alternate embodiment, image 526 is transferred from storage component 410 to stitching component 412.

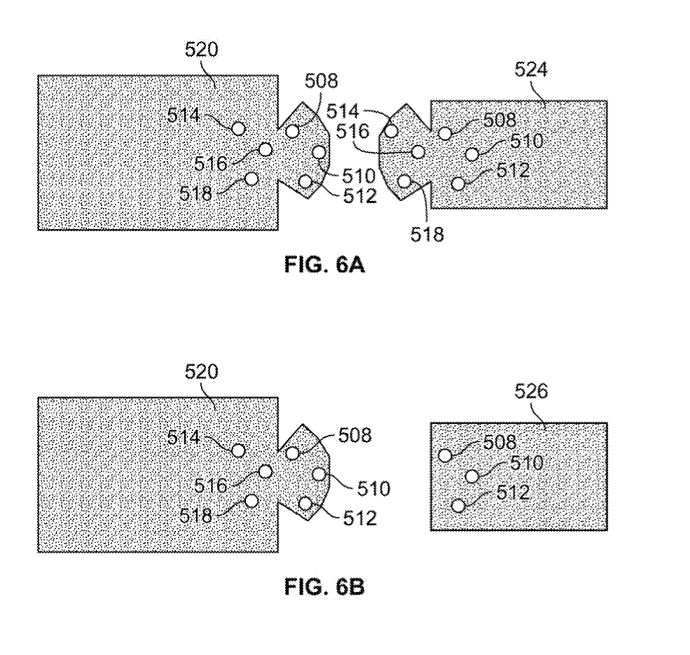

FIGS. 6A-B illustrate stitching of the 3D scanned images according to aspects of the present invention.

As shown in FIG. 6A, stitching component 412 is stitching image 520 and image 524 a third time t₃. It should be noted that in some embodiments, the image data may be stitched together (S312) right when the second 3D image data is received (S308), such that t₂ is substantially the same as t₃, whereas in other embodiments, the image data may be stitched together (S312) long after the second 3D image data is received (S308), such that t₂ is much earlier than t₃.

To stitch the images together, stitching component 412 identifies registration targets in one image and then attempts to identify the equivalent registration targets in another image. In one embodiment, stitching component 412 may identify registration targets 508, 510, 512, 514, 516, and 518 from image 520. Stitching component 412 will then search for the same registration targets in image 524. When stitching component 412 identifies registration targets 508, 510, 512, 514, 516, and 518 within image 524, stitching component 412 combines images 520 and 524 such that each registration target within image 520 is superimposed on the respective registration target within image 524.

As shown in FIG. 6B, in another embodiment, stitching component 412 is stitching image 520 and image 526. To stitch the images together, stitching component 412 identifies registration targets in one image and then attempts to identify the equivalent registration targets in another image. In one embodiment, stitching component 412 may identify registration targets 508, 510, 512, 514, 516, and 518 from image 520. Stitching component 412 will then attempt to identify the same registration targets within image 526, however only registration targets 508, 510, and 512 are identified. Lacking the full set of registration targets in image 526 will not impact the ability to accurately stitch the images together, though.

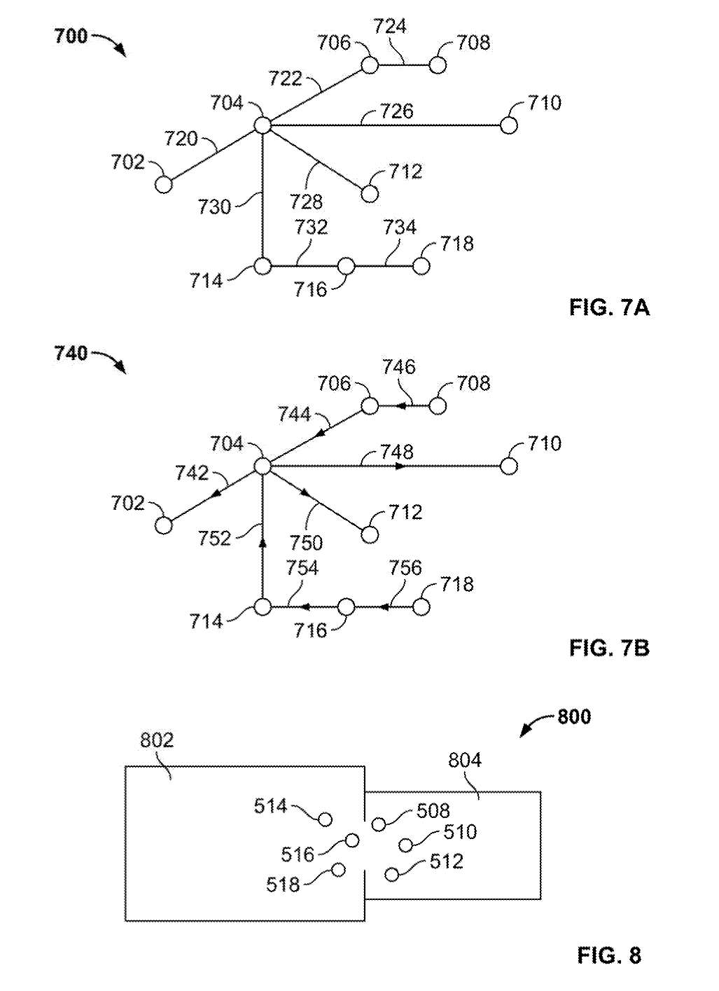

FIGS. 7A-B illustrate a proxy layout 700 and a proxy layout 740, respectively, of floor plan 200 using nodes, lines, and arrows, in accordance with an aspect of the present invention.

As shown in FIG. 7A, proxy layout 700 includes nodes 702, 704, 706, 708, 710, 712, 714, 716, and 718, and lines 720, 722, 724, 726, 728, 732, and 734. Nodes 702, 704, 706, 708, 710, 712, 714, 716, and 718, represent vantage points from which 3D images will be scanned. Based on the space to be imaged, nodes 702, 704, 706, 708, 710, 712, 714, 716, and 718, may represent the center of each room, the corner of each room, throughways between rooms and hallways, or any combination thereof. Lines 720, 722, 724, 726, 728, 732, and 734 represent the connections between nodes 702, 704, 706, 708, 710, 712, 714, 716 and 718. For example, node 704 is connected to node 702 via line 720 and node 714 via line 730. Additional information may be needed though, to fully plan the 3D scan.

Referring now to FIG. 7B, proxy layout 740 includes proxy layout 700 as modified to include arrows 742, 744, 746, 748, 750, 752, 754, and 756, which indicate the direction in which the scan will occur. For example, the scanner may begin to scan the space around node 718, and the scan will occur in the direction of arrow 756, towards node 716. After the space around node 718 is scanned, the space around node 716 is scanned in the direction of arrow 754, towards node 714. This scanning progression will continue until the entire space is scanned according to proxy layout 740.

In accordance with an aspect of the present invention, a space and part of adjacent spaces are captured in order to allow the stitching. However, a significant amount of unnecessary work may be performed if a part of all adjacent spaces are included in each individual scan. For example, FIG. 6A shows an example situation where both sides of a pair have adjacent spaces, whereas FIG. 6B shows an example situation where only one space and part of an adjacent space is captured. To minimize the work performed in scanning, more situations such as shown in FIG. 6B should be performed as opposed to the situations as shown in FIG. 6A. However, the situation where an adjacent space from both sides that is not scanned should be avoided. FIG. 7B illustrates a non-limiting example manner to organize/plan a large scan to ensure there is one adjacent space—the arrow direction indicates which of the two nodes should include the other.

Generally, when 3D imaging any set of adjacent spaces using the present invention, only one of the 3D images of the spaces should capture a 3D image of a portion of the adjacent space for both spaces to be imaged accurately. This will be further described with reference to FIG. 8.

FIG. 8 illustrates the stitched image according to aspects of the present invention.

As shown in the figure, stitched image 800 includes image 802 and image 804. Stitched image 800 is the digital, 3D representation of space 500. Image 802 corresponds to room 502 and image 804 corresponds to room 504.

In one embodiment, and with reference to FIG. 6A, to create stitched image 800, stitching component 412 may first identify registration targets 508, 510, 512, 514, 516, and 518 within image 520. Then, stitching component 412 will attempt to identify the registration targets 508, 510, 512, 514, 516, and 518 within image 524. When stitching component 412 identifies the same registration targets in image 524, stitching component 412 superimposes each registration target from one image onto the corresponding registration target from the other image. For example, when stitching component 412 identifies registration target 508 on images 520 and 524, stitching component manipulates image 520 and image 524 such that registration target 508 from image 520 and registration target 508 from image 524 are co-located within stitched image 800. Proceeding in this manner for each registration target, there are common points that stitching component 412 may use to create stitched image 800.

In another embodiment, and with reference to FIG. 6B, to create stitched image 800, stitching component 412 may first identify registration targets 508, 510, 512, 514, 516, and 518 within image 520. Then, stitching component 412 will attempt to identify the registration targets 508, 510, 512, 514, 516, and 518 within image 526, however stitching component 412 will only identify registration targets 508, 510 and 512 within image 526. Stitching component 412 may proceed with stitching, though, because at least some of the registration targets are common between image 520 and image 526. Instead of matching all six registration targets as discussed with reference to FIG. 6A, only registration targets 508, 510 and 512 are found in both image 520 and image 526. Stitching component 412 manipulates image 520 and image 526 such that registration targets 508, 510 and 512 from image 520 and registration targets 508, 510 and 512 from image 526 are co-located within stitched image 800.

In the non-limiting example embodiment discussed above with reference to FIGS. 5A-D, six registration targets are used for purposes of discussion. It should be noted that any number of registration targets may be used in accordance with aspects of the present invention.

Therefore, stitched image 800 will look the same whether the images are stitched as described in FIG. 6A or as described in FIG. 6B. In addition, because the stitched image is generated using 3D data that extends from room 502 to room 504, stitched image 800 will account for the thickness of the wall in between the two rooms, therefore eliminating the problem of compounding errors found in conventional systems.

Returning to FIG. 3, after image data is stitched together (S312), the stitched image is stored (S314).

Referring to FIG. 4, stitched image 800 is sent from stitching component 412 to storage component 414 such that stitched image 800 can be accessed by a user.

Returning to FIG. 3, after the stitched image is stored (S314), method 300 ends (S316).

With reference to FIG. 4, at some point after stitched image 800 is stored in storage component 414, a user may desire to view stitched image 800 to view the space. To do so, the user may activate display system 434 and navigate to stitched image 800. Upon opening stitched image 800, the user may be able to navigate through the virtual space from any desired perspective. In one embodiment, the user may wish to view the space as though he were walking through the space. In another embodiment, the user may wish to view the space from above. In yet another embodiment, the user may wish to view the space as though the exterior walls of the space did not exist, like a cross section. This type of view may be useful when viewing very large spaces or spaces with many different rooms whose spatial relationship is difficult to understand. For example, a large naval ship may have a multitude of different spaces along its length, and the commander of the ship may find it helpful to view a cross-section of the entire ship to see how the overall space is laid out.

In summary, conventional 3D imaging systems present multiple problems when attempting to create a 3D image of a large space. Because conventional systems require users to scan a large space in a single session, significant preparation and scanning time is involved. In addition, because conventional systems typically provide assumptions regarding wall thicknesses there are often significant dimensional errors compounded over the scans of multiple rooms that result in inaccurate dimensions.

The present invention addresses those problems by providing a user the ability to break up a 3D scan of a large space with multiple rooms into many small scanning sessions while increasing the overall accuracy of the scan. To do so, in some embodiments, registration targets are placed in the rooms to be scanned, whereas in other embodiments natural features already in the space may be used as registration targets. When scanning one room, the scanner also scans a portion of the adjacent room that contains registration targets. Doing so properly accounts for the thickness of the wall in between the two rooms. The scanner then scans the adjacent room which also includes the same registration targets. When the images of the rooms are stitched together, the stitching component matches the registration targets between the scanned rooms, creating a single, accurate image that contains both rooms.

It should also be noted that the invention may permit the work of scanning a large space in parallel to be broken up among multiple independent teams.

The foregoing description of various embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An imaging system comprising:
a first imaging data receiving component operable to receive first three-dimensional image data of a first area and a portion of a second area;
a first data storage component operable to store the first three-dimensional image data;
a second imaging data receiving component operable to receive second three-dimensional image data of the second area and a portion of the first area;
a second data storage component operable to store the second three-dimensional image data;
a stitching component operable to stitch the first three-dimensional image data together with the second three-dimensional image data to produce stitched three-dimensional image data of the first area and the second area; and
a stitched data storage component operable to store the stitched three-dimensional image data;
wherein the first area is separated from the second area by a wall having a thickness and a throughway,
wherein the first area is optically isolated from the second area with an exception of through the throughway,
wherein the portion of the second area comprises a portion of the second area as optically viewed from the first area through the throughway, and
wherein the portion of the first area comprises a portion of the first area as optically viewed from the second area through the throughway.

2. The imaging system of claim 1, further comprising:
a third imaging data receiving component operable to receive third three-dimensional image data of a third area and a second portion of the second area; and
a third data storage component operable to store the third three-dimensional image data,
wherein said second imaging data receiving component is further operable to receive fourth three-dimensional image data of the second area and a portion of the third area,
wherein said stitching component operable to stitch the third three-dimensional image data together with the fourth three-dimensional image data to produce second stitched three-dimensional image data of the third area and the second area,
wherein the stitched data storage component is further operable to store the second stitched three-dimensional image data,
wherein the third area is optically isolated from the second area with an exception of through a second throughway,
wherein the second portion of the second area comprises a second portion of the second area as optically viewed from the third area through the second throughway, and
wherein the portion of the third area comprises a portion of the third area as optically viewed from the second area through the second throughway.

3. The imaging system of claim 2, wherein said stitching component is operable to stitch the first three-dimensional image data together with the second three-dimensional image data to produce the stitched three-dimensional image data of the first area and the second area at a first time t₁.

4. The imaging system of claim 3,
wherein said stitching component is operable to stitch the third three-dimensional image data together with the fourth three-dimensional image data to produce the second stitched three-dimensional image data of the third area and the second area at a second time t₂, and
wherein t₁ is prior to t₂.

5. The imaging system of claim 4, further comprising a three-dimensional imaging device operable to scan the first area and a portion of a second area through the throughway to generate the first three-dimensional image data.

6. The imaging system of claim 5, wherein said three-dimensional imaging device comprises a light distance and ranging device.

7. The imaging system of claim 1, further comprising a three-dimensional imaging device operable to scan the first area and a portion of a second area through the throughway to generate the first three-dimensional image data.

8. The imaging system of claim 7, wherein said three-dimensional imaging device comprises a light distance and ranging device.

9. Method of generating an image, said method comprising:
receiving, via a first imaging data receiving component, first three-dimensional image data of a first area and a portion of a second area;
storing, into a first data storage component, the first three-dimensional image data;
receiving, via a second imaging data receiving component, second three-dimensional image data of the second area and a portion of the first area;
storing, into a second data storage component, the second three-dimensional image data;
stitching, via a stitching component, the first three-dimensional image data together with the second three-dimensional image data to produce stitched three-dimensional image data of the first area and the second area; and
storing, via a third data storage component, the stitched three-dimensional image data;
wherein the first area is separated from the second area by a wall having a thickness and a throughway,
wherein the first area is optically isolated from the second area with an exception of through the throughway,
wherein the portion of the second area comprises a portion of the second area as optically viewed from the first area though the throughway, and
wherein the portion of the first area comprises a portion of the first area as optically viewed from the second area though the throughway.

10. The method of claim 9, further comprising:
receiving, via a third imaging data receiving component, third three-dimensional image data of a third area and a second portion of the second area;
storing, into a third data storage component, the third three-dimensional image data;
receiving, via the second imaging data receiving component, fourth three-dimensional image data of the second area and a portion of the third area;
stitching, via the stitching component, the third three-dimensional image data together with the fourth three-dimensional image data to produce second stitched three-dimensional image data of the third area and the second area; and
storing, into the stitched data storage component, the second stitched three-dimensional image data,
wherein the third area is optically isolated from the second area with an exception of through a second throughway,
wherein the second portion of the second area comprises a second portion of the second area as optically viewed from the third area though the second throughway, and
wherein the portion of the third area comprises a portion of the third area as optically viewed from the second area though the second throughway.

11. The method of claim 10, wherein said stitching, via the stitching component, the first three-dimensional image data together with the second three-dimensional image data to produce stitched three-dimensional image data of the first area and the second area stitching the first three-dimensional image data together with the second three-dimensional image data to produce the stitched three-dimensional image data of the first area and the second area at a first time t₁.

12. The method of claim 11,
wherein said stitching, via the stitching component, the third three-dimensional image data together with the fourth three-dimensional image data to produce second stitched three-dimensional image data of the third area and the second area comprises stitching the third three-dimensional image data together with the fourth three-dimensional image data to produce the second stitched three-dimensional image data of the third area and the second area at a second time t₂, and
wherein t₁ is prior to t₂.

13. The method of claim 12, further comprising scanning, via a three-dimensional imaging device, the first area and a portion of a second area through the throughway to generate the first three-dimensional image data.

14. The method of claim 13, wherein said scanning, via a three-dimensional imaging device, the first area and a portion of a second area through the throughway to generate the first three-dimensional image data comprises scanning a light distance and ranging device.

15. The method of claim 9, further comprising scanning, via a three-dimensional imaging device, the first area and a portion of a second area through the throughway to generate the first three-dimensional image data.

16. The method of claim 15, wherein said scanning, via a three-dimensional imaging device, the first area and a portion of a second area through the throughway to generate the first three-dimensional image data comprises scanning a light distance and ranging device.

17. A system comprising:
a device for:
receiving, via a first imaging data receiving component, first three-dimensional image data of a first area and a portion of a second area;
storing, into a first data storage component, the first three-dimensional image data;
receiving, via a second imaging data receiving component, second three-dimensional image data of the second area and a portion of the first area;
storing, into a second data storage component, the second three-dimensional image data;
stitching, via a stitching component, the first three-dimensional image data together with the second three-dimensional image data to produce stitched three-dimensional image data of the first area and the second area; and
storing, via a third data storage component, the stitched three-dimensional image data;
wherein the first area is separated from the second area by a wall having a thickness and a throughway,
wherein the first area is optically isolated from the second area with an exception of through the throughway,
wherein the portion of the second area comprises a portion of the second area as optically viewed from the first area though the throughway, and
wherein the portion of the first area comprises a portion of the first area as optically viewed from the second area though the throughway.

18. The system of claim 17, wherein said device is further for:
receiving, via a third imaging data receiving component, third three-dimensional image data of a third area and a second portion of the second area;
storing, into a third data storage component, the third three-dimensional image data;
receiving, via the second imaging data receiving component, fourth three-dimensional image data of the second area and a portion of the third area;
stitching, via the stitching component, the third three-dimensional image data together with the fourth three-dimensional image data to produce second stitched three-dimensional image data of the third area and the second area; and
storing, into the stitched data storage component, the second stitched three-dimensional image data,
wherein the third area is optically isolated from the second area with an exception of through a second throughway,
wherein the second portion of the second area comprises a second portion of the second area as optically viewed from the third area though the second throughway, and
wherein the portion of the third area comprises a portion of the third area as optically viewed from the second area though the second throughway.

19. The system of claim 18, wherein said stitching, via the stitching component, the first three-dimensional image data together with the second three-dimensional image data to produce stitched three-dimensional image data of the first area and the second area stitching the first three-dimensional image data together with the second three-dimensional image data to produce the stitched three-dimensional image data of the first area and the second area at a first time t₁.

20. The system of claim 19,
wherein said stitching, via the stitching component, the third three-dimensional image data together with the fourth three-dimensional image data to produce second stitched three-dimensional image data of the third area and the second area comprises stitching the third three-dimensional image data together with the fourth three-dimensional image data to produce the second stitched three-dimensional image data of the third area and the second area at a second time t₂, and
wherein t₁ is prior to t₂.
